(19) United States
(12) Patent Application Publication
(10) Pub. No.: US 2013/0292232 A1
(43) Pub. Date: Nov. 7, 2013

(54) Roller Conveyor and Method for Detecting Synchronization of Rollers

(71) Applicants: Yongqiang Wang, Shenzhen (CN); Chunhao Wu, Shenzhen (CN); Kunhsien Lin, Shenzhen (CN); Xiande Li, Shenzhen (CN); Minghu Qi, Shenzhen (CN); Weibing Yang, Shenzhen (CN); Zenghong Chen, Shenzhen (CN); Zhenhua Guo, Shenzhen (CN); Yunshao Jiang, Shenzhen (CN); Zhiyou Shu, Shenzhen (CN)

(72) Inventors: Yongqiang Wang, Shenzhen (CN); Chunhao Wu, Shenzhen (CN); Kunhsien Lin, Shenzhen (CN); Xiande Li, Shenzhen (CN); Minghu Qi, Shenzhen (CN); Weibing Yang, Shenzhen (CN); Zenghong Chen, Shenzhen (CN); Zhenhua Guo, Shenzhen (CN); Yunshao Jiang, Shenzhen (CN); Zhiyou Shu, Shenzhen (CN)

(73) Assignee: SHENZHEN CHINA STAR OPTOELECTRONICS TECHNOLOGY CO. LTD., Shenzhen (CN)

(21) Appl. No.: 13/519,306

(22) PCT Filed: May 24, 2012
(86) PCT No.: PCT/CN12/75976

§ 371 Date: Jun. 26, 2012

(30) Foreign Application Priority Data
May 7, 2012 (CN) 201210137619.8

(51) Int. Cl. B65G 13/02; B65G 47/00

(52) U.S. Cl. 198/617; 198/780

(57) ABSTRACT

The present invention provides a roller conveyor device used for transferring glass substrates. The device includes a plurality of transaxles arranged in parallel to each other and located coplanarly are incorporated with at least a pair of rollers and each of the rollers is labeled with a mark on its side. The present invention further provides a method for detecting synchronization of rotating rollers. By way of detecting the synchronization or the side marks, each of the rollers can be determined whether it is synchronized with others so as to avoid any detrimental consequences, i.e. breakage or cuts resulted from the asynchronization.

### FIELD OF THE INVENTION

The present invention relates to a technical field of manufacturing of liquid crystal display panel, and more particularly to a roller conveyor and a method for detecting the synchronization of the rollers.

### DESCRIPTION OF PRIOR ART

During the manufacturing of the liquid crystal display panel, the glass substrates are transferred by roller conveyer between different workstations. Basically, the conveyer is configured with rollers installed on transaxles. The rollers are basically made from polyxymethylene (aka POM) or Teflon which feature low-dust-creation, and anti-static. In addition, during the transfer of the glass substrates, it is preferably and ideally that the glass substrates can be transferred under circumstance of a smooth, vibration-free, no side drift, and no damage conveyor. Accordingly, the rollers installed on the conveyor have to be coplanar, and should be synchronized at all time.

However, in reality, in real working environment, each transaxle could be different from each other because of quality issue, it could be damaged by accidental impact, and it could be affected by temperature surge or drop. As a result, those transaxles installed on a roller conveyor could not be guaranteed to rotate synchronically. Once the rollers are rotated asynchronically, frictions will be venerated between the rollers and the glass substrates and eventually resulting cuts or abrasion marks will be found on the glass substrates. On the other hand, as frictions are generated because of asynchronically rotated rollers, balance among the rollers will be encountered and this will eventually make the glass substrates start to vibrate or drill left or right. It may eventually break the glass substrate. In the existing art, once the rollers rotate asynchronically, there is no effective method to detect. Accordingly, no immediate measurement can be taken to resolve this issue. It can only be traced back when damaged glass substrates are found on the produce line. This is detrimental to the yield of the production line.

### SUMMARY OF THE INVENTION

It is an objective of the present invention to provide a technical solution to the prior art, and a roller conveyor and a method for detecting the synchronization of the rollers is therefore provided.

In order to resolve the technical issue encountered by the prior art, a roller conveyor device used for transferring glass substrates, characterized in that wherein a plurality of transaxles arranged in parallel to each other and located coplanarly are incorporated with at least a pair of rollers and each of the rollers is labeled with a mark on its side identifying rotational status of each roller, wherein the mark can be embodied as an embossment or recess with an arrow shape.

Wherein all the marks of each of the rollers are set to a same contour level, and same position before it starts to rotate.

Wherein each of the marks is identified with designated color differentiating color of the rollers.

In order to resolve the technical issue encountered by the prior art, a roller conveyor device used for transferring glass substrates, characterized in that wherein a plurality of transaxles arranged in parallel to each other and located coplanarly are incorporated with at least a pair of rollers and each of the rollers is labeled with a mark on its side.

Wherein all the marks of each of the rollers are set to a same contour level, and same position before it starts to rotate.

Wherein the mark can be embodied as an embossment or recess.

Wherein the embossment or recess is embodied with an arrow shape.

Wherein each of the marks is identified with designated color differentiating color of the rollers.

Wherein both sides of each roller are labeled with marks.

In order to resolve the technical issue encountered by the prior art, a method for detecting synchronization of rotating rollers, characterized in that the method includes the steps of: a) adjusting plurality of transaxles to a coplanar level, and providing each of the transaxles with a plurality of rollers which is labeled with mark at side: b) identifying each the marks on each of the rollers during its rotation whether the marks are located on the same position on each contour; and c) determining a roller is asynchronically rotating when its mark is failed to synchronize with other marks.

Wherein all the marks of each of the rollers are set to a same contour level, and same position before it starts to rotate.

Wherein further includes the step of once an asynchronization is detected, the adrift roller is reset to the same contour level of rollers.

Wherein the step further includes: determining a synchronization of the rollers when all the marks are synchronized at the same position of the same contour level.

In conclusion, by the provision of the present invention of a roller conveyor and a method for detecting the synchronization of the rollers, a synchronization detecting mark is labeled on each of the rollers and the mark can readily help to identify the synchronization of the rollers thereby avoiding any detrimental consequences resulted from asynchronization.

The above described is merely a concise and brief summary of the present invention. A preferred embodiment, along with accompanied drawings will be used to detailedly describe and explain the present invention so as to best understanding of the present invention.

### BRIEF DESCRIPTION OF DRAWINGS

FIG. 1 is an illustration of a roller conveyor device made in accordance with the present invention;

FIG. 2 is an enlarged view of a roller 102 embodied in the roller conveyor device made in accordance with the present invention;

FIG. 3 is a diagram illustrating each step of a method detecting whether rollers are synchronically rotating or not;

FIG. 4 is an illustrational view showing the position of each of the rollers before they start to rotate;

FIG. 5 is an illustrational view showing one of the rollers is adrift from synchronization with others; and

FIG. 6 is an illustrational view showing all the rollers shown in FIG. 4 are synchronically rotated.

### DETAILED DESCRIPTION OF PREFERRED EMBODIMENT

In order clearly explain the technology of the embodiment illustrated in the present invention, a thorough and concise description will be given along with the accompanied drawings. Apparently, the embodiments illustrated in the drawings are merely some typical embodiments and which can be readily modified by the skilled in the art without any additional laborious. It should be noted that they should be all covered by the accompanied claims.

Referring to FIG. 1, which is an illustration of a roller conveyor device made in accordance with the present invention.

The roller conveyor device is used to transfer the glass substrates during the manufacturing of the liquid crystal display panel. It includes a plurality of transaxles 101 and a plurality of rollers 102 installed on each of the transaxles 101. Those transaxles 101 are arranged in the same contour level and are in parallel to each other. Those rollers 102 are fixedly disposed on each of the transaxles 101. In the current embodiment, each of the transaxles 101 is installed with four rollers 102. While in other embodiment, the number of rollers can be altered according to field requirements.

Each of the transaxles 101 further includes a magnetic clutch 102 arranged on an end of each of the transaxles 101. The rotational power of each of the transaxles 101 is generally supplied from a power house, which includes a main coupler (not shown) coupled with those magnetic clutch 103. Once the magnetic clutch 103 is coupled with the main coupler to rotate with it, the transaxles 101 and the rollers 102 are rotated accordingly.

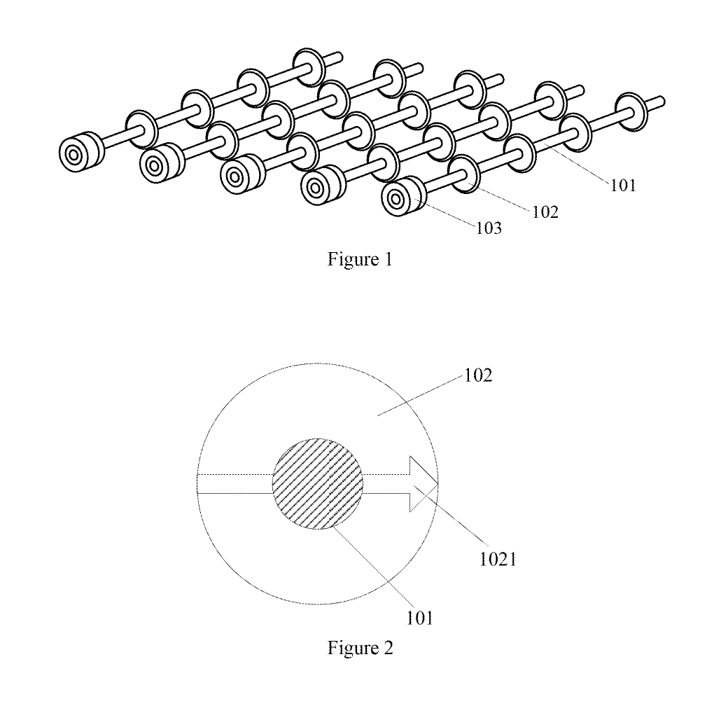

Referring now to FIG. 2, which 2 is an enlarged view of a roller 102 embodied in the roller conveyor device made in accordance with the present invention. Each of the rollers 102 is labeled with a rotating mark 1021 on its side. Preferably, both sides of the roller 102 are labeled with marks 1021. The rotating mark 1021 can be embodied with embossment or recess. For example, during the manufacturing of the rollers 102, recess can be formed on the sides of the rollers 102 with proper mechanical machining. In the present invention, the embossment or recess has an arrow shape. In other embodiment, the rotating mark 1021 can be embodied with other attractive and appealing shapes. In order to distinguishing each of the rollers 102 from others, each of the rotating marks 1021 can be attributed with a designated color differentiating with the color of the roller 102. For example, if the roller 102 has a white color, then the rotating mark 1021 printed with green, yellow and orange which is contrast to the white. Before the rotation of each of the rollers 102, the rotating mark 1021 is set to the same position on the same contour level.

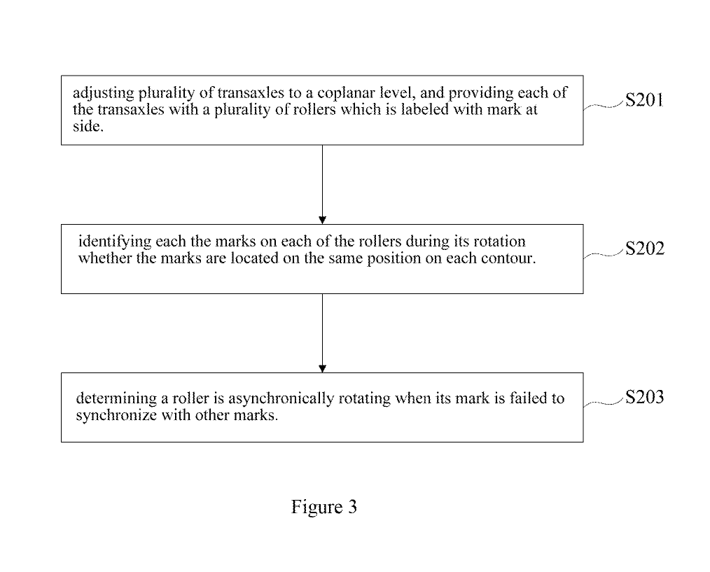

Referring to FIG. 3, which is a diagram illustrating each step of a method detecting whether rollers are synchronically rotating or not. The method of detecting includes the following steps.

Step S201: adjusting plurality of transaxles to a coplanar level, and providing each of the transaxles with a plurality of rollers which is labeled with mark at side.

Wherein the rotating mark is set to an arrow shape as shown in FIG. 2.

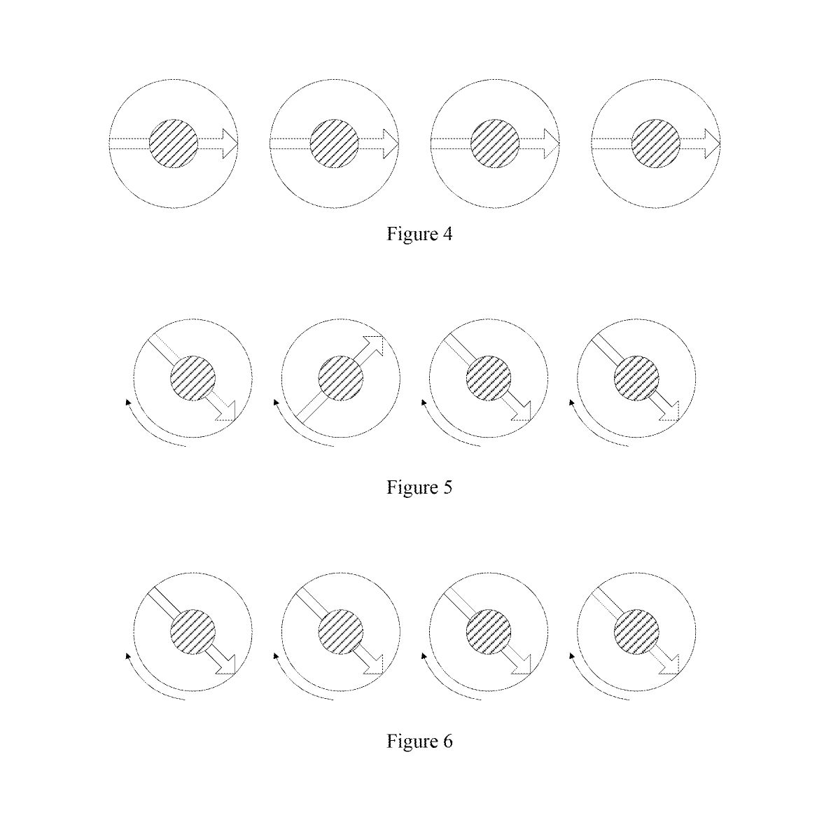

Step S202: identifying each the marks on each of the rollers during its rotation whether the marks are located on the same position on each contour.

Wherein, before the rollers 102 are rotated by the transaxles 102, each of the rotating mark 1021 is set to a pre-determined position on a same contour level. Here, each of the rotating mark is located at the same position on the same contour level means that taking a rotating mark on a typical roller as a standard reference on a preselected contour level, then all of the rest of the rotating marks of the rollers are all located at the same position. Referring to FIG. 4, which is on illustrational view showing the position of each of the rollers before they start to rotate. As shown, all the rotating mark are of an arrow shape, and all of the rotating marks are in parallel to the contour level, and the arrowheads are all pointed to the same direction. Accordingly, the synchronization of rotating marks can be used as a measurement to determine whether a synchronization of the rollers is achieved.

Step S203: determining a roller is asynchronically rotating when its mark is failed to synchronize with other marks.

Substantially, when the rollers are rotating, the rotating marks on the sidewall can be readily detected visually. Accordingly, the maintenance professionals on the side can readily conduct a check routinely so as to make sure all the rollers are rotated synchronically. Referring now to FIG. 5, which is an illustrational view showing one of the rollers is adrift from synchronization with others. It can be readily seen from FIG. 5 that the second roller 102, from left, is apparently adrift from synchronization with the rest of the rollers 102. Based on this observation, the technician can readily notice the existence of asynchronization. Furthermore, the technician can immediately take a corrective measurement to re-adjust the adrift roller, second from the left, so as to have it in synchronization again with the reset of the rollers. Accordingly, the damages from abrasive marks or cuts can be readily avoided beforehand.

The method further includes the step of determining a synchronization of the rollers when all the marks are synchronized at the same position of the same contour level.

Referring to FIG. 6, which an illustrational view showing all the rollers shown in FIG. 4 are synchronically rotated. In FIG. 6, all the rotating marks are correctively aligned on the same contour level and pointed to the same direction. It can be therefore determined that all the rollers are synchronically rotating.

In the present invention, even the rotating marks are used to determine whether the rollers are rotating synchronically, it can also be understood that the rotating marks are representing the rotation of the transaxles. It should be readily understood that the skilled in the art can be readily inspired to determine whether the rollers on the same transaxle are synchronization or not by way of the disclosure of the present invention. Accordingly, determining the rollers on the same transaxle is synchronically rotated or not is also covered by the appended claims.

Furthermore, even the determination of whether the rollers of the transaxles are rotated synchronically is based on visual observation, it should be noted that this method can be included into other suitable inspecting equipment. For example, the rotating mark can be replaced with an electronic detecting device, accordingly, the synchronization of the rollers can be readily conducted by means or the electromagnetic device. Or alternatively, the synchronization of the rollers can be readily conducted by AOI (automatic optic inspection) so as to reduce the labor cost, while increase the efficiency.

By way of the following described device and method, the provision of the present invention of a roller conveyor and a method for detecting the synchronization of the rollers, a synchronization detecting mark is labeled on each of the rollers and the mark can readily help to identify the synchronization of the rollers thereby avoiding any detrimental consequences resulted from asynchronization.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the clams of the present invention.

1. A roller conveyor device used for transferring glass substrates, characterized in that wherein a plurality of transaxles arranged in parallel to each other and located coplanarly are incorporated with at least a pair of rollers and each of the rollers is labeled with a mark on its side identifying rotational status of each roller, wherein the mark can be embodied as an embossment or recess with an straight arrow shape.

2. The roller conveyor device as recited in claim 1, wherein all the marks of each of the rollers are set to a same contour level, and same position before it starts to rotate.

3. The roller conveyor device as recited in claim 1, wherein each of the marks are identified with designated color differentiating color of the rollers.

4. A roller conveyor device used for transferring glass substrates, characterized in that wherein a plurality of transaxles arranged in parallel to each other and located coplanarly are incorporated with at least a pair of rollers and each of the rollers is labeled with a mark on its side.

5. The roller conveyor device as recited in claim 4, wherein all the marks of each of the rollers are set to a same contour level, and same position before it starts to rotate.

6. The roller conveyor device as recited in claim 4, wherein the mark can be embodied as an embossment or recess.

7. The roller conveyor device as recited in claim 6, wherein the embossment or recess is embodied with an arrow shape.

8. The roller conveyor device as recited in claim 4, wherein each of the marks are identified with designated color differentiating color of the rollers.

9. The roller conveyor device as recited in claim 4, wherein both sides of each roller are labeled with marks.

10-13. (canceled)
